(19) United States
(12) Patent Application Publication
(10) Pub. No.: US 2026/0309057 A1
(43) Pub. Date: Oct. 8, 2026

(54) SYSTEM FOR REHEAT STEAM TEMPERATURE TURNDOWN CONTROL IN HEAT RECOVERY STEAM GENERATORS

(71) Applicant: GE Vernova Infrastructure Technology LLC, Greenville, SC (US)

(72) Inventor: Raub Warfield SMITH, Schenectady, NY (US)

(21) Appl. No.: 19/481,339

(22) PCT Filed: May 10, 2023
(86) PCT No.: PCT/US2023/021639

§ 371 Date: Nov. 4, 2025

(51) Int. Cl. F01K 23/10; F22G 1/04; F22G 1/16; F22G 5/12

(52) U.S. Cl. CPC F01K 23/10; F22G 1/04; F22G 1/16; F22G 5/123

(57) ABSTRACT

A steam supply system for a power generation system is disclosed. The steam supply system includes a heat recovery steam generator and a fired reheater. The heat recovery steam generator includes a high-temperature section including a high-pressure superheater and a reheater arranged in series with respect to exhaust gas flowing through the heat recovery steam generator; and, an evaporator downstream from the high-temperature section. The evaporator extracts heat from exhaust gases exiting the high-temperature section. The fired reheater contributes at least a portion of energy necessary to increase a temperature of cold reheat steam to a target temperature.

### BACKGROUND

The field of the disclosure relates generally to gas turbine combined cycle power generation systems, and more particularly, to systems for effectuating steam temperature turndown control in gas turbine combined cycle power generation systems.

Heat exchangers are used to transfer heat from one medium to another in a variety of industries. A heat recovery steam generator (HRSG) is an example of a heat exchanger that may be used in combined cycle power plants to generate steam and additional power from exhaust gases. An HRSG may use gas turbine engine exhaust to heat a fluid flowing through heat exchangers in the HRSG, such as for example, to convert water into steam that is supplied to a steam turbine. In some configurations, the fluid may be steam that is generated at multiple pressure levels and is subsequently channeled to any of the high-pressure, intermediate-pressure, and/or low-pressure sections of a steam turbine. HRSG commonly include a water spray attemperator (desuperheater) to control the temperature of the high pressure and reheat exit steam by combining the superheated steam with water, such that the steam is cooled as the water evaporates.

Some combined cycle power generation systems are configured with a steam turbine extraction to provide process steam in support of industrial, carbon capture, and/or district heating systems. Such steam extractions are commonly pressure-controlled to maintain the process steam supply pressure across a steam flow or plant load operating range. If the plant load or process steam demand moves outside of the permissible operating range for steam extraction from the turbine, there are typically provisions to extract steam from a high-pressure steam source with subsequent pressure and temperature reduction to suit process requirements. This fallback mode is much less efficient since the process steam is no longer initially expanding to do work in a steam turbine. Operation is most efficient when process steam is available from the steam extraction after it has performed work while expanding to the (lower) pressure required for the process. The minimum steam turbine load where process steam extraction is technically feasible is limited because, as load is reduced, the extraction steam temperature gradually increases until the steam turbine components at the extraction point have increased to a temperature that approaches the operating limits for those components. The operating limitation occurs as the pressure ratio for steam expansion across the turbine between a steam inlet (which falls in pressure with flow reduction) and steam extraction (which is controlled to fixed pressure by valves, as required for supply to the process steam user) decreases. The ideal location for steam extraction is often downstream from the intermediate pressure (IP) turbine inlet. Such extraction may lead to a requirement for intermediate-pressure (IP) turbine inlet (reheat) steam temperature turndown control to manage steam temperature leaving the steam turbine extraction. However, reheat steam temperature control with conventional steam temperature control means may be limited. Extending operation with steam extraction active is desired because it is more efficient than shifting process steam supply to a higher pressure and temperature source since such steam no longer has a chance to do any work as it expands through the steam turbine.

Conventional reheat steam temperature control systems with water spray attemperation between reheat sections is limited by the amount of water that can be safely injected and evaporated within the HRSG. It is also inherently inefficient since high level energy is used to evaporate the spray water within the HRSG. A more efficient approach is to utilize cool steam instead of water to decrease the temperature of the steam entering the reheater. This approach however may also be limited in temperature control authority by how much the exit steam temperature can be reduced by mixing.

Therefore, there is a need in the art to extend reheat steam temperature turndown authority in gas turbine combined cycle power generation systems.

### BRIEF DESCRIPTION

In one aspect, a steam supply system for a power generation system is disclosed. The steam supply system includes a heat recovery steam generator having a high-temperature section including a high-pressure superheater and a first reheater arranged in series with respect to exhaust gas flowing through the heat recovery steam generator; and, an evaporator downstream from the high-temperature section, wherein the evaporator extracts heat from exhaust gases exiting the high-temperature section. The steam supply system further includes a second reheater to contribute at least a portion of energy necessary to increase a temperature of cold reheat steam to a target temperature. In some embodiments, the second reheater is arranged in parallel with the first reheater of the high-temperature section. In some embodiments, wherein the second reheater is a fired reheater.

In another aspect, a combined cycle power generation system is disclosed. The combined cycle power generation system includes a gas turbine to generate power and, a heat recovery steam generator having a gas inlet in communication with a gas turbine exhaust stream. The heat recovery steam generator includes a high-temperature section including a high-pressure superheater and a first reheater arranged in series with respect to exhaust gas flowing through the heat recovery steam generator; and, an evaporator downstream from the high-temperature section, wherein the evaporator extracts heat from exhaust gases exiting the high-temperature section. The combined cycle power generation system further includes a second reheater to contribute at least a portion of the energy necessary to increase a temperature of cold reheat steam to a target temperature. The combined cycle power generation system further includes at least one of an intermediate pressure steam turbine and a non-condensing steam turbine configured to receive reheated steam from at least one of the second reheater and the first reheater of the heat recovery steam generator. In some embodiments, the second reheater is arranged in parallel with the first reheater of the high-temperature section. In some embodiments, the second reheater is a fired reheater.

### BRIEF DESCRIPTION OF THE DRAWINGS

FIG. 1 is a schematic diagram of an exemplary prior art supplementary fired power generation system;

FIG. 2 is a schematic diagram of an exemplary supplementary fired power generation system having a steam supply system including a heat recovery steam generator (HRSG) and a fired reheater operating in parallel with an unfired HRSG reheater;

FIG. 3 is a schematic diagram of an exemplary supplementary fired power generation system having a steam supply system including a heat recovery steam generator and a fired reheater performing all steam reheating duty;

FIG. 4 illustrates an exemplary graph of system parameters of the power generation system over plant load for the supplementary fired power generation system of FIG. 1;

FIG. 5 illustrates an exemplary graph of system parameters of the power generation system over plant load for the supplementary fired power generation system of FIG. 2; and,

FIG. 6 illustrates an exemplary graph of system parameters of the power generation system over plant load for the supplementary fired power generation system of FIG. 3.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms, such as “about,” “approximately,” and “substantially,” is not to be limited to the precise value specified. In at least some instances, the approximating language may correspond to the precision of an instrument for measuring the value. Here and throughout the specification and claims, range limitations may be identified. Such ranges may be combined and/or interchanged and include all the sub-ranges contained therein unless context or language indicates otherwise.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

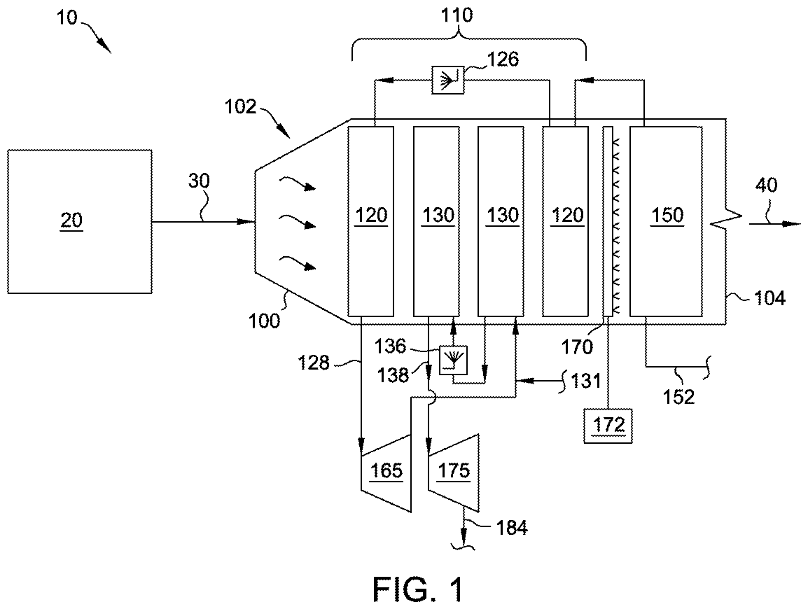

FIG. 1 is a block diagram of the high temperature portion of an exemplary prior art power generation system 10 that includes a gas turbine 20, an HRSG 100, a high-pressure steam turbine 165, and an intermediate pressure steam turbine 175 (referred to as “IP steam turbine 175”). Note that the elements illustrated and labeled in FIG. 1 for the HRSG 100, are only the forward-most sections of interest for this disclosure. The HRSG 100 includes an inlet section 102 and an outlet section interface 104 that directs warm gasses 40 into downstream components of the HRSG 100 including economizers, evaporators, and superheaters for HP, IP, and typically LP steam generation modules (not shown). In some embodiments, the HRSG 100 also includes downstream emissions reduction catalysts (not shown).

The HRSG 100 is an exemplary steam supply system for the prior art power generation system 10. It is therefore understood that the illustrated HRSG 100 is merely illustrative of a steam supply system, and other steam supply systems may be included as part of the illustrated prior art power generation system 10.

In the exemplary prior art embodiment, the HRSG 100 receives hot exhaust gases 30 from the gas turbine 20, which flow through a high-pressure superheater and reheater section (referred to high-temperature section 110), and an evaporator 150. The HRSG 100 is an indirect heat exchanger in which heated water in fluid conduits 152 is provided to the evaporator 150 of the HRSG 100 where heat is extracted from the hot exhaust gas 30 within the HRSG 100.

The high-temperature section 110 includes configurations of reheaters 130 and high-pressure superheaters 120 typically arranged in series. High pressure (HP) steam generated in evaporator 150 is superheated by the exhaust gases 30 flowing through the HRSG 100. The exhaust gases are cooled as the heat is transferred to the steam. The superheater 120 can include a steam outlet 128 in which HP steam exiting the superheater 120 supplies a HP steam turbine 165 coupled to the steam outlet 128 of the superheater 120. Steam flowing through the HP steam turbine 165 is expanded to an intermediate pressure (IP) for reheating prior to the steam being admitted to the IP steam turbine 175. The reheater 130 includes a steam outlet 138 that directs flow to the IP steam turbine 175. Additional IP steam 131 may be added to the HP turbine exhaust steam exiting the HP steam turbine 165 prior to the steam flow entering the reheater 130. The HP steam temperature exiting the steam outlet 128 of the superheater 120, and the IP steam temperature exiting the steam outlet 138 of the reheater 130, are each controlled via an injection of water into the steam at attemperators 126 or 136, respectively. Steam exiting steam outlet 184 of the IP turbine 175 is directed to a low-pressure turbine (not shown) and/or to a process user (not shown).

The evaporator 150 is downstream from the high-temperature section 110 and extracts heat from exhaust gases 30 exiting the high-temperature section 110. In the exemplary embodiment, the evaporator 150 includes a series of fluid tubes (not shown) that extract heat from the exhaust gases 30 exiting the high-temperature section 110. The fluid tubes of the evaporator 150 are coupled by fluid conduits 152 to a HP feed water system (not shown) and to economizing sections (not shown) coupled to a feed water pump system (not shown) that circulates fluid within the system. As the exhaust gases 30 flow through the evaporator 150 and downstream HP economizers, IP and possibly LP steam generation circuits, the exhaust gases are further cooled before being exhausting to a stack or to a downstream process, such as a carbon capture system (CCS).

Combined cycle power generation systems, such as power generation system 10, have a plant operating range that is operationally dependent on power demands of a power grid coupled to the power generation system 10. Many such systems are also responsible to supply the steam demands of a process steam system. Operation with process steam supply is most efficient when the steam has expanded through a steam turbine to do work before extraction to the process steam system. Process steam is typically required at nearly fixed pressure and temperature across the entire operating range of the combined cycle power plant. When the pressure of steam for export to process is controlled at the steam turbine it is said to have an automatic pressure-controlled steam turbine extraction.

While the automatic extraction provision satisfies the steam pressure requirement of the downstream process steam system, extracted steam temperature increases with plant load reduction because the expansion ratio, from turbine section inlet to the extraction point, decreases. At some point the steam or turbine hardware becomes too hot for continued operation of the automatic extraction and an alternate steam supply source must be activated. For example, if the plant load or process steam demands shifts to a demand level that exceeds an operating limit of any component within the power generation system 10 for steam extraction from the turbine, steam may instead be drawn from a high-pressure steam source, such as the at least one high pressure superheater 120. Such a process also requires suitable pressure and temperature reduction to comply with process requirements and to maintain the power generation system 10 within an acceptable plant operating range. As used herein, the term “low load” or “minimum load” refers to an operating state of the plant wherein the power generation system 10 is operating at or near a minimum permissible operating state, and the term “high load” or “base load” refers to an operating state of the plant wherein the power generation system 10 is operating at or near a maximum permissible operating state of the plant.

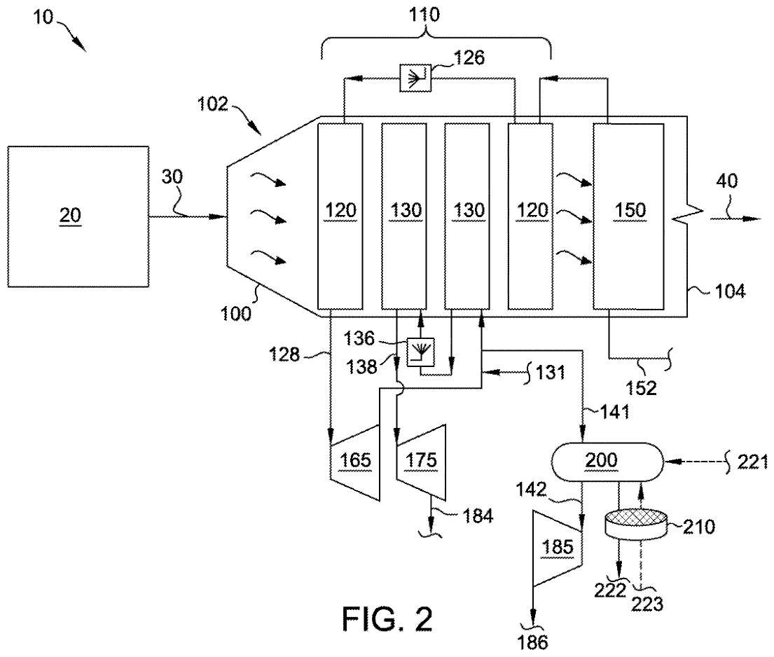

FIG. 2 is a schematic diagram of an exemplary power generation system 10 that includes an HRSG 100, HP steam turbine 165, IP steam turbine 175, fired reheater 200, regenerative air heater 210, and a dedicated process steam supply steam turbine 185 (referred to hereinafter as “non-condensing steam turbine 185” and/or “NCST 185”). In some embodiments the non-condensing steam turbine 185 may alternatively be configured as a condensing section with a pressure controlled automatic extraction, or more generally a dedicated process steam turbine. In the exemplary embodiment, the HRSG 100 includes the high-temperature section 110 including configurations of reheaters 130 and high-pressure superheaters 120 typically arranged in series, and an HP evaporator 150 downstream from the high-temperature section 110. The HRSG 100 includes an inlet section 102 and an outlet section interface 104 that directs warm gases 40 into the HRSG including applicable economizers, evaporators, and superheaters for high pressure (HP), intermediate pressure (IP), and/or low pressure (LP) steam generation modules. In some embodiments, the HRSG 100 also includes emissions reduction catalysts (not shown).

The HRSG 100 is an exemplary steam supply system for the power generation system 10. It is therefore understood that the illustrated HRSG 100 is merely illustrative of a steam supply system, and other steam supply systems may be included as part of the illustrated power generation system 10. In the illustrated embodiments, the steam supply system includes the HRSG 100 and the fired reheater 200. In some embodiments, the fired reheater 200 is a separate component from the HRSG 100. In some embodiments, the fired reheater 200 is an integral component from the HRSG 100

The evaporator 150 downstream from the high-temperature section 110 extracts additional heat from the exhaust gases exiting the high-temperature section 110. In some embodiments, the evaporator 150 is a once-through high pressure evaporator through which feed water from fluid conduits 152 (shown in FIG. 1) within the HP feed water system (not shown) is channeled therethrough. The HRSG 100 includes enclosing walls that define a heating gas duct through which the exhaust gases 30 gas from gas turbine 20 (as shown in FIG. 1 where flow is indicated by reference arrow 30).

In the exemplary embodiment, the high-temperature section 110 includes at least one high pressure superheater 120 coupled in a series orientation with a reheater 130. The superheater 120 includes a gas inlet 122 and a gas outlet 124, and the reheater 130 includes a gas inlet and a gas outlet. Cold reheat steam is apportioned between the reheaters 130 of the HRSG 100 and a dedicated fired reheater 200. Steam reheated in fired reheater 200 is supplied to a NCST 185 (or condensing steam turbine with automatic extraction) which provides steam at controlled pressure to a process user. Fuel is provided to fired reheater 200 via line 221. Air is provided via air line 223 which is heated in counter flow to exhaust stream 222 in a regenerative air heater 210. The fired reheater exhaust stream 222 is exhausted to atmosphere or sent to a downstream system for carbon capture.

In the exemplary embodiment, the fired reheater 200 heats intermediate pressure steam to a pre-determined target steam temperature. The fired reheater fuel supply 221 and air supply 223 are coordinated to maintain low excess air for combustion and hence high efficiency for this subsystem across its load range. As target reheat steam temperature is decreased; fuel 221 and air 223 are also decreased. Diversion of cold reheat steam to the fired reheater 200 also impacts high pressure steam generation and hence high pressure and hot reheat steam temperature from the HRSG 100, and in particular the steam outlets 128 and 138. Increased intermediate pressure steam flow to the fired reheater 200 from cold reheat reduces the reheating duty in the reheaters 130 of the HRSG 100 and hence increases the gas temperature and energy available to evaporator 150 for HP steam generation. Modulation of the fuel firing rate in the fired reheater 200 provides full authority control of steam supply temperature to the NCST 185 via line 142 from a minimum of the cold reheat steam temperature in line 141 and rated steam temperature, typically ~300° F. (165° C.) hotter, whereas no conventional HRSG configuration has more than ~100° F. (55° C) control range on reheat steam temperature. This enables the NCST 185 exhaust steam (or extraction steam in the case of an auto-extraction design) feeding a process to be maintained below its limiting temperature value to a lower minimum load turndown with pressure-controlled steam turbine extraction active than would be possible for any prior art design having much more limited reheat steam temperature control range. Modulation of the fuel firing rate in the fired reheater eliminates the need for any other steam temperature control system (attemperator) on this steam circuit.

The fired reheater 200 can combust fuel at a variable fire rate to provide temperature control of the steam provided to process 186, allowing the reheater 130 to be sized and positioned within the high-temperature section 110 of the HRSG 100 to provide rated steam temperature to the IP steam turbine 175 at base load of a combined cycle power generation system (such as the power generation system 10) with fired reheater 200 rated cold reheat (IP) steam flow diverted to process via steam line 141. The fuel 221 provided to the fired reheater 200 can be selectively varied to facilitate controlling reheat steam temperature to process supply NCST 185 as gas turbine and process steam demand is varied to facilitate maintaining steam export temperature within material limits at 186. Steam temperature to IP steam turbine 175 via stream 138 is controlled conventionally to maximize thermal performance of the power plant 10, completely independently from steam exiting the fired reheater via stream 142 to NCST 185. The minimum reheat steam temperature with zero fuel 221 to fired reheater 200 facilitates achieving the target IP turbine exhaust temperature at minimum possible load turndown with pressure-controlled steam turbine exhaust (or extraction) active.

The fired reheater 200 is selectively operable with no fuel, or a wide intermediate range of fuel and air supply between a minimum operating state and a maximum firing rate. In the non-operating state, the fuel 221 and air 223 are disabled or is otherwise not operable such that the fired reheater 200 is not combusting fuel. In contrast, while in the maximum fuel 221 and air 223 firing rate, the fired reheater 200 is operating at a level wherein it is combusting approximately the maximum amount of fuel that the fired reheater 200 is rated for. During the intermediate firing rate, fired reheater 200 operates at a combustion rate that is between the maximum burner firing rate and the non-operating state. As explained in further detail below, the fired reheater 200 facilities direct control of reheat steam temperature by operating with a selectively variable firing rate.

During the low load operating state of the power generation system 10, it is desirable to maintain a reduced reheat temperature of steam entering the NCST 185 from the fired reheater 200 to limit extraction steam temperature and prevent overheating of components. To achieve low reheat steam temperature to NCST 185 at the minimum load operating state with pressure-controlled extraction operating, the system can be configured such that supply of fuel 221 and air 223 to fired reheater 200 is not needed, and the fired reheater 200 is thus placed in the non-fired state. The fired reheater 200 can also be selectively operated in the intermediate burner firing rate to enable control of reheat steam temperature from line 142 to NCST 185 and thus facilitate best achievable system efficiency with respect to reheat steam temperatures at plant loads above the minimum.

As the load on the system is increased, the supply of fuel 221 and air 223 to fired reheater 200 can be selectively modulated in the intermediate firing range to adapt to the changing load conditions. In the high load operating state of the power generation system 10, steam flow is increased through the system generally, and more specifically to the NCST 185. During such operating conditions, a higher temperature of reheat steam entering the NCST 185 can be achieved by operating the supply of fuel 221 and air 223 to fired reheater 200 up to its maximum firing rate.

Variably operating the fired reheater 200 in response to system load demands, enables temperature control of supply steam 142 entering the process steam supply NCST 185 from the fired reheater 200. Thus, in some embodiments, depending on process steam demand, the fuel and air lines 221 and 223 to the fired reheater 200 can be selectively modulated to enable a steady supply of temperature-controlled process steam from an automatic extraction (if NCST 185 is a condensing turbine) or exhaust (if NCST 185 is a non-condensing turbine). For example, if the steam flow demands of the process user receiving stream 186 decrease, the firing rate of the fired reheater 200 can be appropriately reduced to maintain stream 186 below its limiting temperature without additional attemperation provisions because the fired reheater 200 has direct control of reheat steam temperature from line 142.

In all embodiments, the fired reheater 200 may use a dedicated air supply to enable low excess air operation independent of bulk gas turbine exhaust gas O₂ concentration. Such a configuration facilitates maximizing thermal efficiency as well as exhaust CO₂ concentration to a carbon capture and storage (CCS) system, and thus facilitates reducing CCS capture costs. In the preferred embodiment, air is provided via air line 223 which is heated in counter flow to exhaust stream 222 in a regenerative air heater 210. The exhaust stream 222 of the fired reheater exhaust 200 is exhausted to atmosphere or sent to a downstream system for carbon capture. In some embodiments, the fired reheater 200 may include a catalyst system to reduce emissions. In some alternate embodiments the exhaust 222 from the fired reheater 200 may be mixed into the HRSG 100 ahead of the HRSG's own emissions reduction catalyst system. In this instance the opportunity to regeneratively heat combustion air 223 against exhaust stream 222 is sacrificed so air supply to the fired reheater may be unheated or heated regeneratively by other means (water from the HRSG, steam from a steam turbine, etc.).

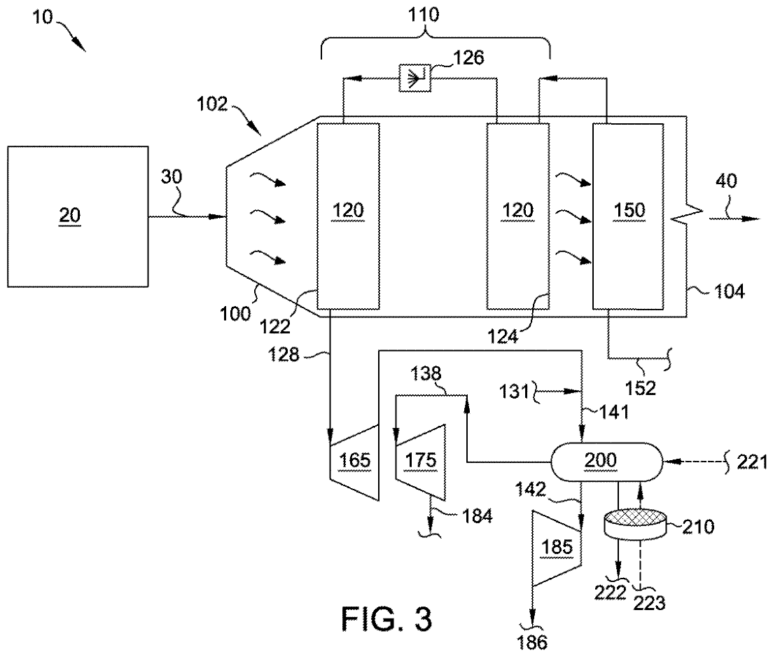

FIG. 3 is a schematic diagram of an exemplary power generation system 10 that includes an HRSG 100, HP steam turbine 165, IP steam turbine 175, fired reheater 200, regenerative air heater 210, and NCST 185. Steam supply to a process at controlled pressure may be provided either from an automatic extraction (or IP exhaust) of the IP steam turbine 175 or the exhaust of NCST 185. In the exemplary embodiment, the HRSG 100 includes the high-temperature section 110 including high-pressure superheaters 120. An HP evaporator 150 is arranged downstream from the high-temperature section 110. The HRSG 100 includes an inlet section 102 and an outlet section interface 104 that directs warm gases 40 into the HRSG including applicable economizers, evaporators, and superheaters for high pressure (HP), intermediate pressure (IP), and/or low pressure (LP) steam generation modules. In some embodiments, the HRSG 100 also includes emissions reduction catalysts (not shown).

The evaporator 150 downstream from the high-temperature section 110 extracts additional heat from the exhaust gases exiting the high-temperature section 110. In some embodiments, the evaporator 150 is a once-through high pressure evaporator through which feed water from fluid conduits 152 (shown in FIG. 1) within the HP feed water system (not shown) is channeled therethrough. The HRSG 100 includes enclosing walls that define a heating gas duct through which the exhaust gases 30 gas from gas turbine 20 (as shown in FIG. 1 where flow is indicated by reference arrow 30).

In the exemplary embodiment, the high-temperature section 110 includes at least one high pressure superheater 120. The superheater 120 includes a gas inlet 122 and a gas outlet 124. Cold reheat steam is directed to a dedicated fired reheater 200. Steam reheated in fired reheater 200 is supplied to either an IP steam turbine 175 with process steam extraction provision and/or NCST 185 which exhausts steam at controlled pressure to a process user. Fuel is provided to fired reheater 200 via line 221. Air is provided via air line 223 which is heated in counter flow to exhaust stream 222 in a regenerative air heater 210. The fired reheater exhaust stream 222 is exhausted to atmosphere or sent to a downstream system for carbon capture.

In the exemplary embodiment, the fired reheater 200 heats intermediate pressure steam to a pre-determined target steam temperature. The fired reheater fuel supply line 221 and air supply line 223 are coordinated to maintain low excess air for combustion and hence high efficiency for this subsystem across its load range. As target reheat steam temperature is decreased; fuel 221 and air 223 are also decreased. Diversion of all cold reheat steam to the fired reheater maximizes HP steam generation and plant output above what is achievable with the system depicted in FIG. 2. Modulation of the fuel firing rate in the fired reheater provides full authority control of steam supply temperature to the IP steam turbine 175 via line 138 and the NCST 185 via line 142 from a minimum of the cold reheat steam temperature in line 141 and rated steam temperature, typically ~300 ° F. (165° C.) hotter. This enables the IP steam turbine 175 extraction (or exhaust) steam 184, and/or NCST 185 exhaust 186, feeding a process to be maintained below their limiting temperature values. This capability in turn enables plant operation to a lower minimum load turndown with pressure-controlled steam turbine extraction(s) active than is possible for any prior art design having more limited reheat steam temperature control range. Coordination of reheat steam supply to, and process steam from, IP steam turbine 175 and NCST 185 adds further flexibility to achieve efficient operation at low loads in relation to FIG. 2. Modulation of the fuel firing rate in the fired reheater eliminates the need for any other steam temperature control system (attemperator) on this steam circuit.

The fired reheater 200 can combust fuel at a variable fire rate to provide temperature control of the steam provided to process via 184 and/or 186. The fuel 221 provided to the fired reheater 200 can be selectively varied to facilitate controlling reheat steam temperature to IP steam turbine 175 and NCST 185 as gas turbine and process steam demand is varied to facilitate maintaining steam export temperature within material limits at 184 and/or 186. The minimum reheat steam temperature with zero fuel 221 to fired reheater 200 facilitates achieving the target IP turbine exhaust temperature at minimum possible load turndown with pressure-controlled steam turbine exhaust (or extraction) active. The capability to selectively shut off steam flow to IP steam turbine 175 or NCST 185 further extends the operable range for process steam supply from a steam turbine extraction.

The fired reheater 200 is selectively operable with no fuel, or a wide intermediate range of fuel and air supply between a minimum operating state and a maximum firing rate. In the non-operating state, the fuel 221 and air 223 are disabled or is otherwise not operable such that the fired reheater 200 is not combusting fuel. In contrast, while in the maximum fuel 221 and air 223 firing rate, the fired reheater 200 is operating at a level wherein it is combusting approximately the maximum amount of fuel that the fired reheater 200 is rated for. During the intermediate firing rate, fired reheater 200 operates at a combustion rate that is between the maximum burner firing rate and the non-operating state. As explained in further detail below, the fired reheater 200 facilities direct control of reheat steam temperature by operating with a selectively variable firing rate.

During the low load operating state of the power generation system 10, it is desirable to maintain a reduced reheat temperature of steam entering the IP steam turbine 175 and/or NCST 185 from the fired reheater 200 to limit extraction steam ftemperature and prevent overheating of components. To achieve low reheat steam temperature to IP steam turbine 175 and/or NCST 185 at the minimum load operating state with automatic extraction operating, the system can be configured such that supply of fuel 221 and air 223 to fired reheater 200 is not needed, and the fired reheater 200 is thus placed in the non-fired state. The fired reheater 200 can also be selectively operated in the intermediate burner firing rate to enable control of reheat steam temperature 138 to IP steam turbine 175 and/or line 142 to NCST 185 and thus facilitate best achievable system efficiency with respect to reheat steam temperatures at plant loads above the minimum. The capability to selectively shut off steam flow to IP steam turbine 175 or NCST 185 further extends the operable range for process steam supply from a steam turbine extraction.

As the load on the system is increased, the supply of fuel 221 and air 223 to fired reheater 200 can be selectively modulated in the intermediate firing range to adapt to the changing load conditions. Similarly, if either the IP steam turbine 175 or NCST 185 was offline, this steam turbine can be activated to enable higher load operation. In the high load operating state of the power generation system 10, steam flow is increased through the system generally, and more specifically to the intermediate pressure steam turbines 175 and NCST 185. During such operating conditions, a higher temperature of reheat steam entering the IP steam turbines 175 and/or NCST 185 can be achieved by operating the supply of fuel 221 and air 223 to fired reheater 200 up to its maximum firing rate.

Variably operating the fired reheater 200 in response to system load demands, enables temperature control of supply steam of the steam outlet 138 entering IP steam turbine 175 and/or 142 entering the NCST 185 from the fired reheater 200. Thus, depending on process steam demand, the fuel and air lines 221 and 223 supplied to the fired reheater 200 can be selectively modulated to enable a steady supply of temperature-controlled process steam from an automatic extraction of IP steam turbine 175 or exhaust from NCST 185. For example, if the steam flow demands of the process user receiving process stream decrease, the firing rate of the fired reheater 200 can be appropriately reduced to maintain streams 184 and/or 186 below their limiting temperatures without additional attemperation provisions because the fired reheater 200 has direct control of reheat steam temperature from line 142.

In all embodiments, the fired reheater 200 may use a dedicated air supply to enable low excess air operation independent of bulk gas turbine exhaust gas O₂ concentration. Such a configuration facilitates maximizing thermal efficiency as well as exhaust CO₂ concentration to a carbon capture and storage (CCS) system, and thus facilitates reducing CCS capture costs. In the preferred (most efficient) embodiment, air is provided via air line 223 which is heated in counter flow to exhaust stream 222 in a regenerative air heater 210. The fired reheater exhaust stream 222 is exhausted to atmosphere or sent to a downstream system for carbon capture. In some embodiments, the fired reheater may include a catalyst system to reduce emissions. In some alternate embodiments the exhaust from the fired reheater may be mixed into the HRSG ahead of the HRSG's own emissions reduction catalyst system. In this instance the opportunity to regeneratively heat combustion air 223 against exhaust stream 222 is sacrificed so air supply to the fired reheater may be unheated or heated regeneratively by other means (water from the HRSG, steam from a steam turbine, etc.).

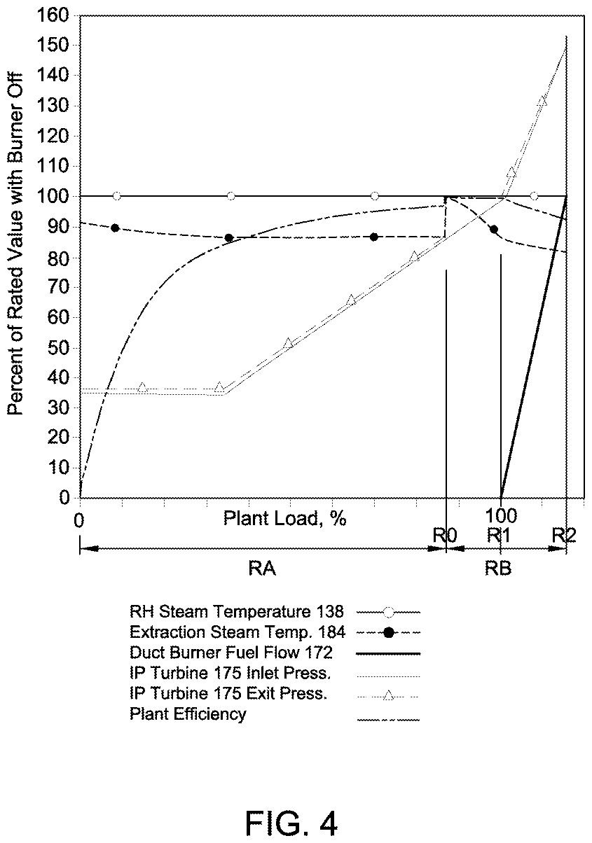

FIG. 4 illustrates an exemplary graph of system parameters of a power generation system over plant load for exemplary prior art supplementary fired power generation system of FIG. 1. As shown, the power generation system operates at a range RA which corresponds to a load range (>0 and <R0) where the power generation system is operating with backup steam to process, and a range RB which corresponds to a load range (>R0 and <R2) where the power generation system is operating with automatic steam extraction to process. Load R1 at 100% Plant Load represents operation with the gas turbine at base load and the duct burner off, such that full firing on the duct burner increases plant load at R2 to approximately 116%.

Throughout the range RA, the duct burner 170 is non-operational and no burner fuel 172 is being fed to the duct burner 170. At the low end of range RB between R0 and R1, extraction steam temperature is at a maximum temperature even though duct burner 170 is non-operational so further unloading requires a mode change to RA with cessation of automatic extraction of process steam from a steam turbine and initiation of the backup stream supply for process steam. This causes a step change loss in plant output and efficiency since process steam is now being throttled from a higher pressure without work extraction by a steam turbine. As the power generation system begins to operate above load R0 with automatic steam extraction active, the extraction steam temperature decreases due to increasing pressure ratio across the IP steam turbine 175. Load R1 and peak plant efficiency is reached at gas turbine base load with the automatic extraction valve fully open and the duct burner non-operational. Higher plant load with steam turbine extraction still active is available in this configuration with initiation of fuel 172 to duct burner 170. As shown, extraction pressure is no longer controlled by the automatic extraction as it floats up with increasing steam flow. This requires process steam to be separately throttled down to process pressure in the extraction steam line supply to process. Depending on burner placement and HRSG design, fuel flow 172 to duct burner 170 can provide up to 150% of unfired steam flow and associated plant increased output. Even though process steam is expanding through the steam turbine before export to process, incremental efficiency is quite low in this upper end of operating range RB. This system could be designed such that steam export with full firing did not need to be throttled in the process steam supply line to slightly improve efficiency at fully fired point R2, but range RB would shrink and RA would increase.

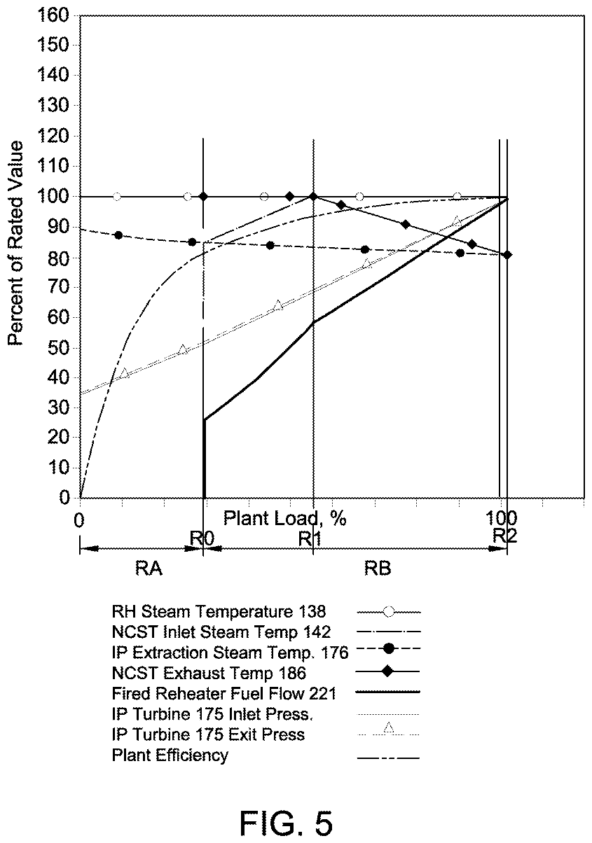

FIG. 5 illustrates an exemplary graph of system parameters of an exemplary power generation system over plant load configured with a heat recovery steam generator and a fired reheater operating in parallel with the unfired HRSG reheater of FIG. 2. As shown, the power generation system operates at a range RA which corresponds to a load range (>0 and <R0) where the power generation system is operating with backup steam to process, and a range RB which corresponds to a load range (>R0 and <R2) where the power generation system is operating with fixed pressure steam extraction to process from NCST 185. Plant load R2 represents operation with the gas turbine at base load and the fired reheater fully fired to bring reheat steam from line 142 to rated temperature. This is shown as ~102%, which reflects the heat energy added to the reheat steam from line 142 by the fired reheater, incremental to the energy available from the gas turbine exhaust alone in the HRSG. The output boost from the fired reheater may be higher or lower depending on cycle steam conditions and flow split between steam supply to the IP turbine 175 and the NCST 185. Note that while FIGS. 2 and 5 include both an IP steam turbine 175 and NCST 185, this system could also be configured without the NCST 185, with or without process steam extraction 184 from IP steam turbine 175.

Throughout the range RA, the fired reheater 200 is non-operational, no burner fuel 221 is being fed to the fired reheater 200, and the NCST 185 is non-operational. At the low end of range RB between R0 and R1, extraction steam temperature is at a maximum temperature controlled by fuel flow 221 and air flow 223 to fired reheater 200. Further unloading requires a mode change to RA with cessation of pressure-controlled supply of process steam from NCST 185 and initiation of the backup steam supply for process steam. This mode boundary may be governed by fuel and air turndown of the fired reheater, throttling capability of the process steam pressure control valve, or other hardware, sizing, or control constraint. As the power generation system begins to operate above load R0 with pressure-controlled supply of process steam from NCST 185 active, the export steam temperature is controlled to its limit by controlling steam temperature from the fired reheater 200, which is increased as pressure ratio across the NCST 185 increases with load. At and above load R1 the steam supply temperature in line 142 is controlled at its rated value and steam export temperature to process 186 from NCST 185 decreases as expansion pressure ratio across NCST 185 continues to increase. Peak plant efficiency is reached just shy of gas turbine base load and falls only slightly as plant load increases to R2. Incremental efficiency with fired reheat operation is about 50% higher than for duct burner operation in the FIG. 1 prior art at base gas turbine load, hence the very modest efficiency drop-off for the extra 2% plant output condition at R2. At part load the incremental efficiency of the fired reheater actually improves plant efficiency above unfired operation for the prior art system in FIG. 1.

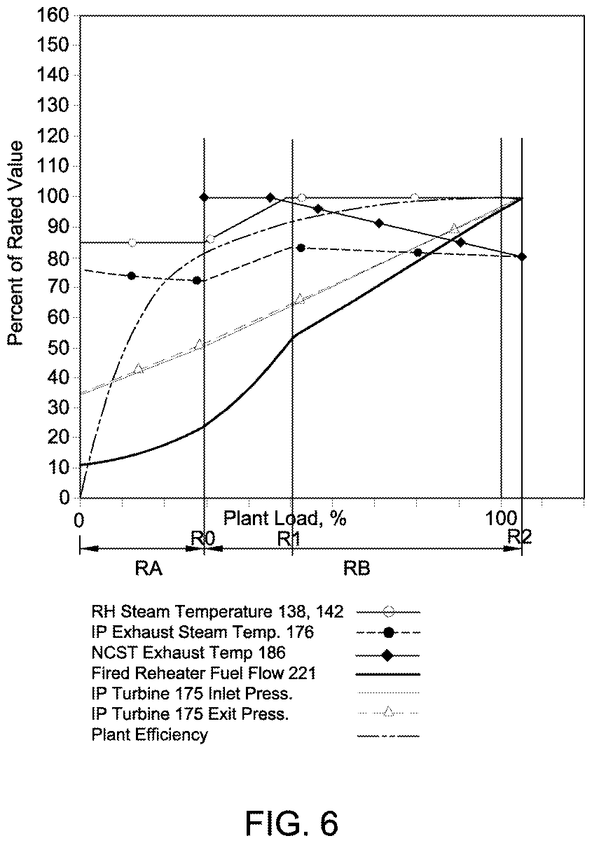

FIG. 6 illustrates an exemplary graph of system parameters of an exemplary power generation system over plant load configured with heat recovery steam generator and a fired reheater serving all HP steam turbine 165 exhaust and IP steam generated in the HRSG 100 of FIG. 3. As shown, the power generation system operates at a range RA which corresponds to a load range (>0 and <R0) where the power generation system is operating with backup steam to process, and a range RB which corresponds to a load range (>R0 and <R2) where the power generation system is operating with fixed pressure steam extraction to process from a NCST 185. Plant load R2 represents operation with the gas turbine at base load and the fired reheater fully fired to bring reheat steam from steam outlet 138 and 142 to rated temperature. This is shown as ~105%, which reflects the heat energy added to the cold reheat steam line 141 by the fired reheater, incremental to the energy available from the gas turbine exhaust alone in the HRSG. The output boost from the fired reheater may be higher or lower depending on cycle steam conditions. Note that while FIGS. 3 and 6 include both an IP steam turbine 175 and a NCST 185, this system could also be configured without the NCST 185, with or without process steam extraction 184 from IP steam turbine 175.

Throughout the range RA, the fired reheater 200 is operational to manage IP steam turbine 175 inlet temperature, and the NCST 185 is non-operational. At the low end of range RB between R0 and R1, extraction steam temperature is at a maximum temperature controlled by fuel flow 221 and air flow 223 to fired reheater 200. Further unloading requires a mode change to RA with cessation of pressure-controlled supply of process steam from a NCST 185 and initiation of the backup steam supply for process steam. This mode boundary may be governed throttling capability of the process steam pressure control valve, or other hardware, sizing, or control constraint. As the power generation system begins to operate above load R0 with pressure-controlled supply of process steam from NCST 185 active, the export steam temperature is controlled to its limit by controlling steam temperature from the fired reheater 200, which is increased as pressure ratio across the NCST 185 increases with load. Since steam from steam outlet 138 to IP steam turbine 175 is also coming from the fired reheater 200, IP steam turbine exhaust temperature varies with fuel 221 and air flow 223 supplied to the fired reheater. At and above load R1 the steam supply temperature in steam lines 138 and 142 is controlled at its rated value and steam export temperature to process 186 from NCST 185 decreases as expansion pressure ratio across NCST 185 continues to increase. Peak plant efficiency is reached just shy of gas turbine base load and falls only slightly as plant load increases to R2. Incremental efficiency with fired reheat operation is about 50% higher than for duct burner operation in the FIG. 1 prior art at base gas turbine load, hence the very modest efficiency drop-off for the extra 5% plant output condition at R2. At part load the incremental efficiency of the fired reheater actually improves plant efficiency above unfired operation for the prior art system in FIG. 1. This is modest so not visually discernable on these figures.

The systems described herein facilitate enhanced and wider range reheat steam temperature control during combined cycle turndown conditions. In particular, a fired reheater operating in parallel with an HRSG that supplies reheat steam to an intermediate pressure steam turbine or independently to heat all cold reheat steam. Variably operating the fired reheater to control reheat steam temperature to the intermediate pressure steam turbine with automatic extraction, and/or NCST also supplied by reheat steam, greatly extends the range of loads across which steam can be supplied to process after expansion through a steam turbine. Thus, depending on the process steam and power demand, the fired reheater can be variably modulated in coordination with gas turbine load and exhaust flow to provide the required supply of process steam from a steam turbine to maintain operation within hardware operating limits. For example, if equipment within the power generation system requires a lower reheat steam temperature, the firing rate of the fired reheater can be appropriately reduced. When all of the steam reheating is by the fired reheater, no reheat steam attemperation provisions are required because fuel and air supply to the fired reheater are directly modulated to control exit steam temperature. Even in the case where the fired reheater is operating in parallel with a reheater in the unfired HRSG, reheat steam temperature control in the HRSG may be substantially or fully achieved by managing the steam flow through the fired reheater. In known systems, spray water and steam mixing for the purposes of steam temperature control lack the necessary control authority within the HRSG to substantially extend steam extraction to process operation to low loads with pressure-controlled (automatic) steam turbine extraction active.

The methods, systems, and compositions disclosed herein are not limited to the specific embodiments described herein, but rather, steps of the methods, elements of the systems, and/or elements of the compositions may be utilized independently and separately from other steps and/or elements described herein. For example, the methods, systems, and compositions are not limited to practice with only a rotary machine as described herein. Rather, the methods, systems, and compositions may be implemented and utilized in connection with many other applications.

Although specific features of various embodiments may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, any feature of a drawing may be referenced and/or claimed in combination with any feature of any other drawing.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention can be practiced with modification within the spirit and scope of the claims.

Further aspects of the invention are provided by the subject matter of the following clauses:

According to a first aspect, a steam supply system for a power generation system, the steam supply system including: a heat recovery steam generator including: a high-temperature section including a high-pressure superheater and a first reheater arranged in series with respect to exhaust gas flowing through the heat recovery steam generator; and, an evaporator downstream from the high-temperature section, wherein the evaporator extracts heat from exhaust gases exiting the high-temperature section; and, a second reheater to contribute at least a portion of energy necessary to increase a temperature of cold reheat steam to a target temperature.

The steam supply system according to the preceding aspect, wherein the second reheater is arranged in parallel with the first reheater of the high-temperature section.

The steam supply system according to any preceding aspect, wherein the second reheater is a fired reheater.

The steam supply system according to any preceding aspect, wherein the second reheater combusts fuel from a fuel source at a variable fire rate.

The steam supply system according to any preceding aspect, wherein the second reheater is coupled to a dedicated air supply, wherein the dedicated air supply enables low excess air operation.

The steam supply system according to any preceding aspect, wherein the second reheater is selectively operable in any of three operating states including non-operating state wherein the second reheater is not combusting fuel, a maximum burner firing rate wherein the second reheater is operating at its maximum energy input, and an intermediate burner firing rate that is less than the maximum burner firing rate and that is more than the non-operating state.

The steam supply system according to any preceding aspect, wherein the steam supply system is coupled to a gas turbine of a combined cycle power generation system.

The steam supply system according to any preceding aspect, wherein the operation of the gas turbine, the second reheater, and cold reheat steam flow split between the second reheater and the first reheater is coordinated to manage the steam temperature leaving the first reheater to supply an intermediate pressure steam turbine such that the first reheater does not require attemperation to modulate reheat steam temperature.

The steam supply system according to any preceding aspect, wherein cold reheat steam flow is shifted from the second reheater to the first reheater to facilitate lowering exit temperature of the first reheater.

The steam supply system according to any preceding aspect, wherein airflow to the gas turbine is increased to facilitate lowering the exit temperature of the first reheater.

The steam supply system according to any preceding aspect, wherein the first reheater is sized and configured to provide rated temperature steam to an intermediate pressure steam turbine operating at a maximum load of a combined cycle power generation system with a rated portion of cold reheat steam flow directed to the second reheater.

The steam supply system according to any preceding aspect, wherein the second reheater is selectively operable at or near the maximum burner firing rate when the combined cycle power generation system is at high load.

The steam supply system according to any preceding aspect, wherein the second reheater is selectively operable at the intermediate burner firing rate wherein the reheat steam temperature is selectively modulated to enable a steady supply of process steam from at least one of an automatic pressure-controlled steam turbine extraction and a non-condensing steam turbine.

The steam supply system according to any preceding aspect, wherein the second reheater does not require attemperation to modulate reheat steam temperature.

A combined cycle power generation system including: a gas turbine to generate power; a heat recovery steam generator having a gas inlet in communication with a gas turbine exhaust stream, the heat recovery steam generator including: a high-temperature section including a high-pressure superheater and a first reheater arranged in series with respect to exhaust gas flowing through the heat recovery steam generator; and, an evaporator downstream from the high-temperature section, wherein the evaporator extracts heat from exhaust gases exiting the high-temperature section; a second reheater to contribute at least a portion of the energy necessary to increase a temperature of cold reheat steam to a target temperature; and, at least one of an intermediate pressure steam turbine and a non-condensing steam turbine configured to receive reheated steam from at least one of the second reheater and the first reheater of the heat recovery steam generator.

The combined cycle power generation system according to the preceding aspect, wherein the second reheater is arranged in parallel with the first reheater of the high-temperature section.

The combined cycle power generation system according to any preceding aspect, wherein the second reheater is a fired reheater.

The combined cycle power generation system according to any preceding aspect, wherein the second reheater combusts fuel from a fuel source at a variable fire rate.

The combined cycle power generation system according to any preceding aspect, wherein the second reheater is coupled to a dedicated air supply, wherein the dedicated air supply enables low excess air operation.

The combined cycle power generation system according to any preceding aspect, wherein the second reheater is selectively operable in any of three operating states including a non-operating state wherein the second reheater is not combusting fuel, a maximum burner firing rate wherein the second reheater is operating at its maximum energy input, and an intermediate burner firing rate that is less than the maximum burner firing rate and that is more than the non-operating state.

The combined cycle power generation system according to any preceding aspect, wherein the first reheater of the heat recovery steam generator is sized and configured to provide rated steam temperature to at least one of an intermediate pressure steam turbine and a non-condensing steam turbine operating at base load of a combined cycle power generation system with a rated portion of the cold reheat steam flow directed to the second reheater.

The combined cycle power generation system according to any preceding aspect, wherein the second reheater is selectively operable at or near the maximum burner firing rate when the combined cycle power generation system is at high load.

The combined cycle power generation system according to any preceding aspect, wherein the second reheater is selectively operable at an intermediate burner firing rate wherein the reheat steam temperature is selectively modulated to enable a steady supply of process steam from an automatic pressure-controlled steam turbine extraction and exhaust of the non-condensing steam turbine.

The combined cycle power generation system according to any preceding aspect, wherein the second reheater and the heat recovery steam generator do not require attemperation to modulate reheat steam temperature.

What is claimed is:

1. A steam supply system for a power generation system, the steam supply system comprising:
a heat recovery steam generator comprising:
a high-temperature section including a high-pressure superheater and a first reheater arranged in series with respect to exhaust gas flowing through the heat recovery steam generator; and,
an evaporator downstream from the high-temperature section, wherein the evaporator extracts heat from exhaust gases exiting the high-temperature section; and,
a second reheater to contribute at least a portion of energy necessary to increase a temperature of cold reheat steam to a target temperature.

2. The steam supply system of claim 1, wherein the second reheater is arranged in parallel with the first reheater of the high-temperature section.

3. The steam supply system of claim 1, wherein the second reheater is a fired reheater.

4. The steam supply system of claim 3, wherein the second reheater combusts fuel from a fuel source at a variable fire rate.

5. The steam supply system of claim 4, wherein the second reheater is coupled to a dedicated air supply, wherein the dedicated air supply enables low excess air operation.

6. The steam supply system of claim 1, wherein the second reheater is selectively operable in any of three operating states including non-operating state wherein the second reheater is not combusting fuel, a maximum burner firing rate wherein the second reheater is operating at its maximum energy input, and an intermediate burner firing rate that is less than the maximum burner firing rate and that is more than the non-operating state.

7. The steam supply system of claim 6, wherein the steam supply system is coupled to a gas turbine of a combined cycle power generation system.

8. The steam supply system of claim 7, wherein the operation of the gas turbine, the second reheater, and cold reheat steam flow split between the second reheater and the first reheater is coordinated to manage the steam temperature leaving the first reheater to supply an intermediate pressure steam turbine such that the first reheater does not require attemperation to modulate reheat steam temperature.

9. The steam supply system of claim 8, wherein cold reheat steam flow is shifted from the second reheater to the first reheater to facilitate lowering exit temperature of the first reheater.

10. The steam supply system of claim 8, wherein airflow to the gas turbine is increased to facilitate lowering the exit temperature of the first reheater.

11. The steam supply system of claim 6 wherein the first reheater is sized and configured to provide rated temperature steam to an intermediate pressure steam turbine operating at a maximum load of a combined cycle power generation system with a rated portion of cold reheat steam flow directed to the second reheater.

12. The steam supply system of claim 11, wherein the second reheater is selectively operable at or near the maximum burner firing rate when the combined cycle power generation system is at high load.

13. The steam supply system of claim 6, wherein the second reheater is selectively operable at the intermediate burner firing rate wherein the reheat steam temperature is selectively modulated to enable a steady supply of process steam from at least one of an automatic pressure-controlled steam turbine extraction and a non-condensing steam turbine.

14. The steam supply system of claim 6, wherein the second reheater does not require attemperation to modulate reheat steam temperature.

15. A combined cycle power generation system comprising:
a gas turbine to generate power;
a heat recovery steam generator having a gas inlet in communication with a gas turbine exhaust stream, the heat recovery steam generator comprising:
a high-temperature section including a high-pressure superheater and a first reheater arranged in series with respect to exhaust gas flowing through the heat recovery steam generator; and,
an evaporator downstream from the high-temperature section, wherein the evaporator extracts heat from exhaust gases exiting the high-temperature section;
a second reheater to contribute at least a portion of the energy necessary to increase a temperature of cold reheat steam to a target temperature; and,
at least one of an intermediate pressure steam turbine and a non-condensing steam turbine configured to receive reheated steam from at least one of the second reheater and the first reheater of the heat recovery steam generator.

16. The combined cycle power generation system of claim 15, wherein the second reheater is arranged in parallel with the first reheater of the high-temperature section.

17. The combined cycle power generation system of claim 15, wherein the second reheater is a fired reheater.

18. The combined cycle power generation system of claim 17, wherein the second reheater combusts fuel from a fuel source at a variable fire rate.

19. The combined cycle power generation system of claim 18, wherein the second reheater is coupled to a dedicated air supply, wherein the dedicated air supply enables low excess air operation.

20. The combined cycle power generation system of claim 17, wherein the second reheater is selectively operable in any of three operating states including a non-operating state wherein the second reheater is not combusting fuel, a maximum burner firing rate wherein the second reheater is operating at its maximum energy input, and an intermediate burner firing rate that is less than the maximum burner firing rate and that is more than the non-operating state.

21. The combined cycle power generation system of claim 20, wherein the first reheater of the heat recovery steam generator is sized and configured to provide rated steam temperature to at least one of an intermediate pressure steam turbine and a non-condensing steam turbine operating at base load of a combined cycle power generation system with a rated portion of the cold reheat steam flow directed to the second reheater.

22. The combined cycle power generation system of claim 21, wherein the second reheater is selectively operable at or near the maximum burner firing rate when the combined cycle power generation system is at high load.

23. The combined cycle power generation system of claim 20, wherein the second reheater is selectively operable at an intermediate burner firing rate wherein the reheat steam temperature is selectively modulated to enable a steady supply of process steam from an automatic pressure-controlled steam turbine extraction and exhaust of the non-condensing steam turbine.

24. The combined cycle power generation system of claim 23, wherein the second reheater and the first reheater do not require attemperation to modulate reheat steam temperature.
